(19) United States
(12) Patent Application Publication
(10) Pub. No.: US 2011/0129148 A1
(43) Pub. Date: Jun. 2, 2011

(54) IMAGE PROCESSING USING TARGET VALUES

(76) Inventors: Pavel Kisilev, Maalot (IL); Boris Oicherman, Kiriat Tivon (IL)

(21) Appl. No.: 12/808,568

(22) PCT Filed: Dec. 17, 2007
(86) PCT No.: PCT/US07/87825

§ 371 Date: Jun. 16, 2010

(51) Int. Cl. G06K 9/00; G06K 9/36

(52) U.S. Cl. 382/167; 382/276

(57) ABSTRACT

Provided are, among other things, systems, methods and techniques for processing an image. In one representative implementation, input image values are obtained for an input image; values for image parameters are measured across the input image values; target values for the image parameters are input; a transformation is applied to the input image values to produce corresponding output image values, the transformation having been generated as a result of a plurality of individual image-value operations that have been constrained by the target values in order to control the image parameters across the output image values; and a processed output image is output based on the output image values.

### FIELD OF THE INVENTION

The present invention pertains to systems, methods and techniques for image processing.

### BACKGROUND

Image enhancement frequently involves a number of operations aimed at image brightness and/or contrast modification. Such operations can include, e.g.: (i) image histogram stretching or dynamic range stretching, (ii) gamma correction (e.g., for brightening or darkening the image), (iii) shadow brightening and/or (iv) highlight darkening.

A variety of different image-processing techniques exist, some employing one or more of such operations. Usually, such tasks are performed sequentially, with each operation being performed by applying a transformation (e.g., one- or multi-dimensional look-up-table, LUT) to each pixel of a two-dimensional image or to one or more image frames in a video sequence. However, the present inventors have discovered that sequential application of multiple individual operations often results in unintended consequences, e.g., with the later operations eliminating some of the benefits of earlier operations and with the user often losing a significant amount of control over the final output image. Furthermore, sequential application typically requires more computations and multiple memory access, as compared to a single LUT application.

### SUMMARY OF THE INVENTION

Accordingly, the present invention concerns, among other things, image-processing techniques in which multiple individual operations are performed on an image.

More specifically, in order to address the above-identified problems of conventional techniques, one embodiment of the invention is directed to processing an image, in which input image values are obtained for an input image (which, in turn, may be a modification of another image, e.g., a linearly or non-linearly filtered original image, a sub-sampled original image, etc.); values for image parameters are measured across the input image values; target values for the image parameters are input; a transformation is applied to the input image values to produce corresponding output image values, the transformation having been generated as a result of a plurality of individual image-value operations that have been constrained by the target values in order to control the image parameters across the output image values; and a processed output image is output based on the output image values (and potentially based on other information, such as the image values for the input image and/or the image values for the original image, if any).

Another embodiment is directed to processing an image, in which input values are obtained for pixels in an input image; target values are input to replace identified ones of the input values; a transformation is applied to the input values for the pixels in order to produce corresponding output image values, the transformation including multiple two or more individual image-value operations and mapping the identified ones of the input values to the target values; and a processed output image is output based on the output image values.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram showing one representative context in which the present invention may be used.

FIG. 2 illustrates the basic problem of converting an input image into a desired output image.

FIG. 3 illustrates the transformation of individual pixel values to achieve a desired output image.

FIG. 4 illustrates an exemplary histogram of pixel values for an input image.

FIG. 5 conceptually illustrates the transformation of a range of input pixel values to a range of output pixel values according to a representative embodiment of the present invention.

FIG. 6 is a flow diagram illustrating a process for providing an image transformation according to a first representative embodiment of the present invention.

FIG. 7 illustrates pseudocode for constructing an image-processing transformation according to a representative embodiment of the present invention.

FIG. 8 illustrates the ranges of pixel values for each individual operations of a transformation according to a representative embodiment of the present invention.

FIG. 9 is a flow diagram illustrating a process for providing an image transformation according to a second representative embodiment of the present invention.

FIG. 10 illustrates an exemplary graphical user interface according to a first representative embodiment of the present invention.

FIG. 11 is a flow diagram illustrating a process for providing an image transformation according to a third representative embodiment of the present invention.

FIG. 12 illustrates an exemplary graphical user interface according to a second representative embodiment of the present invention.

### DESCRIPTION OF THE PREFERRED EMBODIMENT(S)

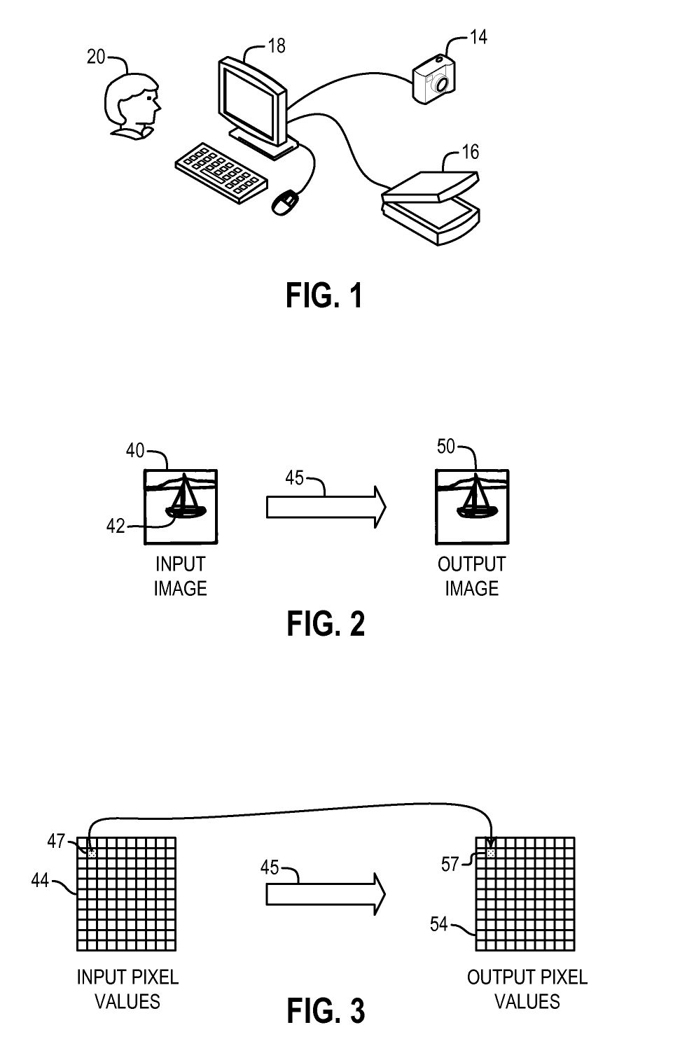

The present invention generally pertains to digital image processing techniques. As indicated in FIG. 1, an original digital image can be generated from a variety of different devices, such as a digital camera 14 or a scanner 16. Once available on a computer 18, a user 20 often will want to enhance or correct the original image in order to improve its visual appearance and/or to highlight certain details. Two features that commonly are adjusted are brightness and contrast, although other image features can be adjusted as well.

In any event, as shown in FIG. 2, the present invention generally assumes the existence of some input image 40 which is converted through a transformation process 45 according to the present invention into an output image 50. Although the input image 40 often will be the entire original source image (e.g., as received from digital camera 14 or scanner 16), the input image 40 instead could be some designated (manually or automatically designated) portion of the original source image, such as just the sailboat 42. That is, the processing techniques of the present invention can be applied separately to specified regions of a larger image.

A transformation process 45 according to certain embodiments of the present invention treats the input image 40 as an array of pixel elements (pixels), transforming the set of pixel values 44 that make up the input image 40 into a corresponding set of pixel values 54 that make up the output image 50. In most of the embodiments discussed below, the pixel value for each pixel 47 in the input image 40 is converted into a value for the corresponding pixel 57 (meaning, in this context, at the same pixel location) in the output image 50. More preferably, this conversion is in accordance with a single formula or mapping that is dependent upon the pixel value for such pixel 47, but is not directly dependent upon pixel values for other pixels (although, as noted above, it can be dependent upon certain aggregate statistics for the input image pixels 44). However, in alternate embodiments the output value for an individual pixel 57 might depend upon the input value for the corresponding pixel 47 and/or other pixels in the input image 40 (e.g., pixels surrounding or in the neighborhood of the corresponding pixel 47).

For monochromatic images, the pixel value ordinarily will be the brightness, lightness, luminance or intensity value of the pixel. For color images, the pixel values can be any of the three values (or channels) that define the pixel's color, in any color space. In other words, the techniques of the present invention can be applied to any arbitrary chosen axis in any image color space, such as Lightness, Chroma, Saturation, Hue or an individual primary color, or even to a number of different dimensions simultaneously (i.e., to any combination of axes, by constructing a multivariate transformation or LUT). In the examples given below, the terminology generally reflects an assumption that the pixel value is intensity; however, such examples are intended merely to better communicate certain concepts and are not intended to be limiting.

More generally, although many of the examples discussed herein refer to pixel values, the present invention is applicable to any kinds of values that represent an image or any aspect thereof (referred to herein as “image values”). For example, all of the techniques described herein can be applied to any transformation (e.g., Fourier, cosine, wavelet or any other frequency-domain, orthogonal or unitary transformation) of any pixel values. As with the spatial-domain example given above, the techniques of the present invention can be applied to only portions of such alternate-domain representations and/or such techniques may be applied differently (e.g., using different parameters) to different portions of the image values, irrespective of the particular domain or even where the input image is segmented in one domain and processed in another. In one representative embodiment, an input image first is separated into a low-frequency (smoothed) component and a high-frequency (transitions, edges, etc.) component, the present technique is applied (either in the frequency domain or in the spatial/pixel domain) to the low-frequency component, and finally the high-frequency component (either modified or not) is added back. As will be readily apparent, large numbers of variations are possible.

The present techniques often can be applied similarly in all such variations. However, as noted above, in order to simplify the explanation, the primary examples described herein pertain to pixel intensities. Generally speaking, unless the context indicates otherwise, references herein to intensity values can be extended to any kind of pixel values or image values, and references herein to pixel values can be extended to any kind of image values. Thus, when the following discussion refers to “dynamic range”, such references can be applied not only the lightness channel values, but to a range of values in any chosen domain. For instance, “Gamut Mapping” refers to an operation whereby the colors of an image are mapped from one range (“Gamut”) to another. In such an operation, the present techniques may be applied to the Chroma dimension; in this case, the “dynamic range” will represent a range of Chroma image values (sometimes referred to as the “Gamut boundary”).

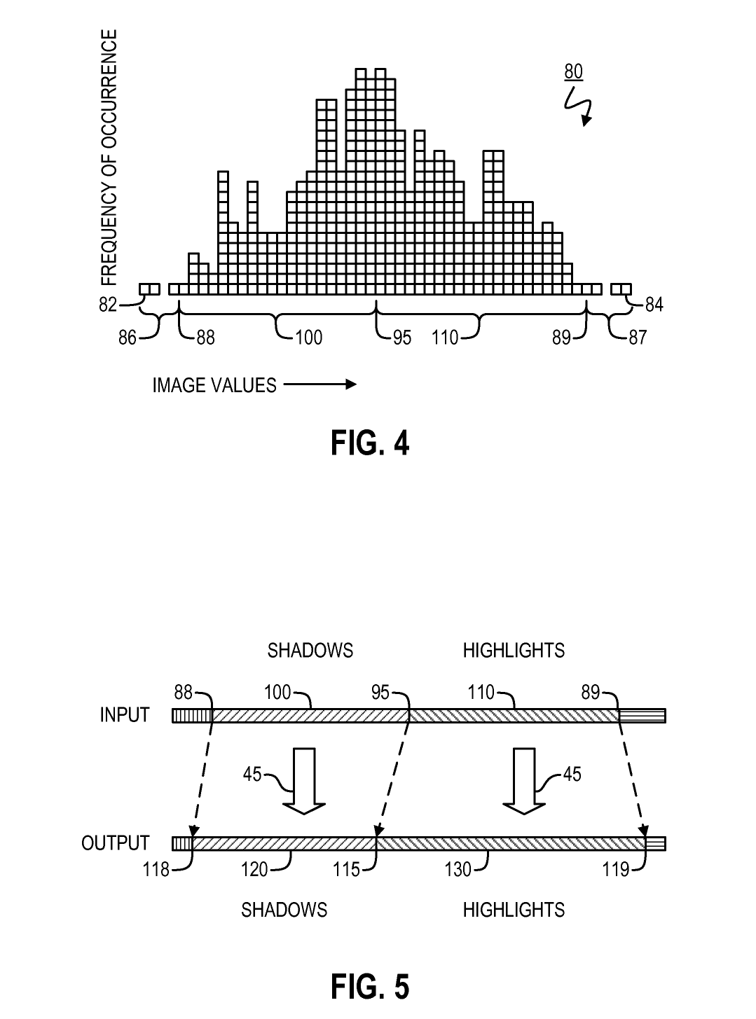

In certain embodiments, it is desirable to base the image processing on measured values across the input image 40. For this purpose, it often is useful to consider the image values within the input image 40 in terms of a histogram, such as histogram 80 shown in FIG. 4. As indicated, the horizontal axis indicates image value, e.g., pixel intensity (increasing from left to right), and the vertical axis indicates frequency of occurrence, or in this example, number of pixels having a particular intensity.

Using this representation, it is possible to define a dynamic range within which the pixel values fall. While it is possible to use the entire range of pixel values, i.e., from pixel value 82 to pixel value 84, this entire range typically will include a number of outliers that do not need to be considered. Accordingly, it is preferable to define the applicable dynamic range as excluding certain values on a very low end 86 and certain values on the very high end 87.

In one specific example, the low outliers 86 are defined to be any values below a specified “low percentile” (e.g., below percentile 1), and the high outliers 87 are defined to be any values above a specified “high percentile” (e.g., above percentile 99). Stated mathematically, if h̅(x) is the normalized cumulative histogram of channel values, i.e.,

$$\overline{h} ( x ) = \frac{{\sum }_{y = 0}^{x} h ( y )}{{\sum }_{y = 0}^{255} h ( y )} ,$$

then “input shadows” Sh_X 88 (which is the cutoff for the low outliers 86 and, as discussed more fully below, the beginning of the shadows 100) is the value of x such that h̅(Sh_X)≦0.01 and h̅(Sh_X+1)>0.01, and “input highlights” Hl_X 89 (which is the cutoff for the high outliers 87 and, as discussed more fully below, the end of the highlights 110) is the value of x such that h̅(Hl_X) 0.99 and h̅(Hl_X+1)>0.99. It is noted that the low percentile and high percentile need not be equally wide and/or any other criterion may be used for defining the low outliers 86 and the high outliers 87.

In the preferred embodiments, it is also preferable to define a midpoint of a range of the input pixel values. Such a midpoint can be defined, e.g., as the average, median or other statistical measure of the channel histogram. For example, the midpoint 95, referred to as the “input mid-tone” Mt_X, is defined as the median of the channel histogram, i.e., h̅(Mt_X)≦0.5 and h̅(Mt_X+1)>0.5; it is noted that in embodiments where the low outliers 86 and the high outliers 87 have the same percentile width, this median value also is the median of the defined dynamic range. In alternate embodiments, e.g., in embodiments where the low outliers 86 and high outliers 87 have different percentile widths, the midpoint is defined relative to the defined dynamic range, rather than the entire range of input pixel values. The identification of a midpoint (e.g., Mt_X 95) ordinarily divides the defined dynamic range into two contiguous segments, which ordinarily are referred to herein as the shadows 100 and the highlights 110.

One aspect of the preferred embodiments of the present invention is the mapping of certain parameters of the input image or certain input image values to designated target parameters of the output image or designated output target image values, respectively, or at least the controlling of the input parameters or input image values based on designated target parameters or image values, respectively. It is noted that each of the lower endpoint of the dynamic range Sh_X 88, the upper endpoint of the dynamic range Hl_X 89 and the dynamic range midpoint or the input mid-tone Mt_X 95 is both an image value and a measured parameter across the input image 40.

In a representative embodiment of the invention, the overall image-processing transformation maps these values to other designated target values, while at the same time performing other image-processing operations. This mapping of values is illustrated conceptually in FIG. 5. Here, the image-processing transformation 45 is constrained to such that the lower endpoint of the dynamic range Sh_X 88, the upper endpoint of the dynamic range Hl_X 89 and the input mid-tone Mt_X 95 are mapped exactly to corresponding designated target values Sh_Y 118, Hl_Y 119 and Mt_Y 115, respectively. New ranges of shadows 120 and highlights 130 result, with the user (e.g., a natural person 20 or an automated process running on computer 18) having direct control over not only the entire dynamic range, but also the proportions of the dynamic range that are allocated to shadows and to highlights.

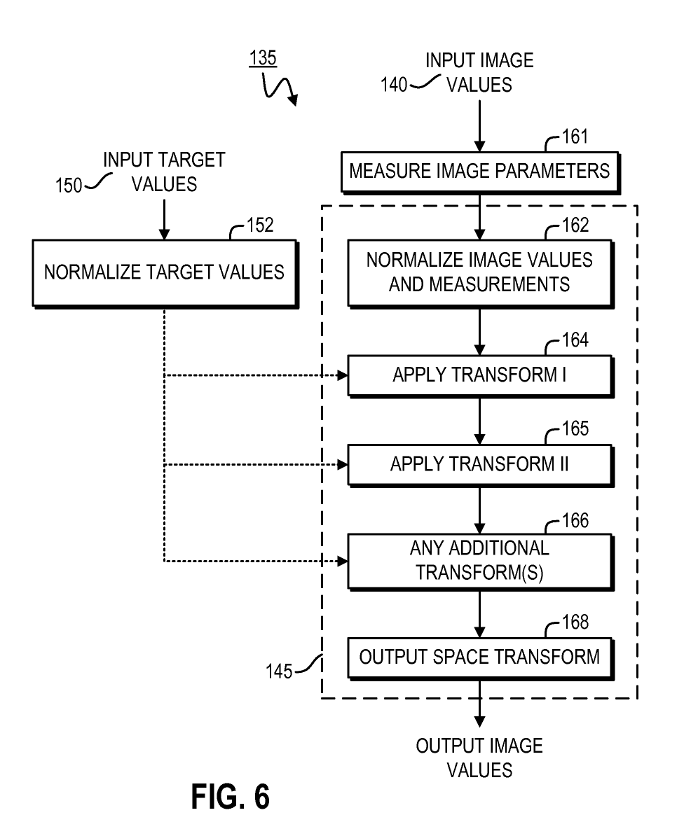

An example of such a process 135 is now described with reference to FIGS. 6-8. Preferably, the steps of the process 135 are performed in a fully automated manner so that the entire process 135 can be performed by executing computer-executable process steps from a computer-readable medium (which can include such process steps divided across multiple computer-readable media), or in any of the other ways described herein.

Input into the process 135 are image values 140 (pixel intensity values in the present example) for the input image 40 and target values 150. In the present example, target values 150 include the values Sh_Y 118, Hl_Y 119 and Mt_Y 115 to which the lower endpoint of the dynamic range Sh_X 88, the upper endpoint of the dynamic range Hl_X 89 and the input mid-tone Mt_X 95, respectively, are to be mapped. The overall transformation 145 that is to be applied to the input pixel values 140 generally represents one subset of the range of possible transformations 45 that may be applied according to the present invention.

Initially, in step 161 certain parameters are measured across the input image values 140. In the present example, such parameters are the lower endpoint of the dynamic range Sh_X 88, the upper endpoint of the dynamic range Hl_X 89 and the input mid-tone Mt_X 95. However, any other parameters pertaining to the input image 40 instead may be measured in step 161 and used throughout process 135.

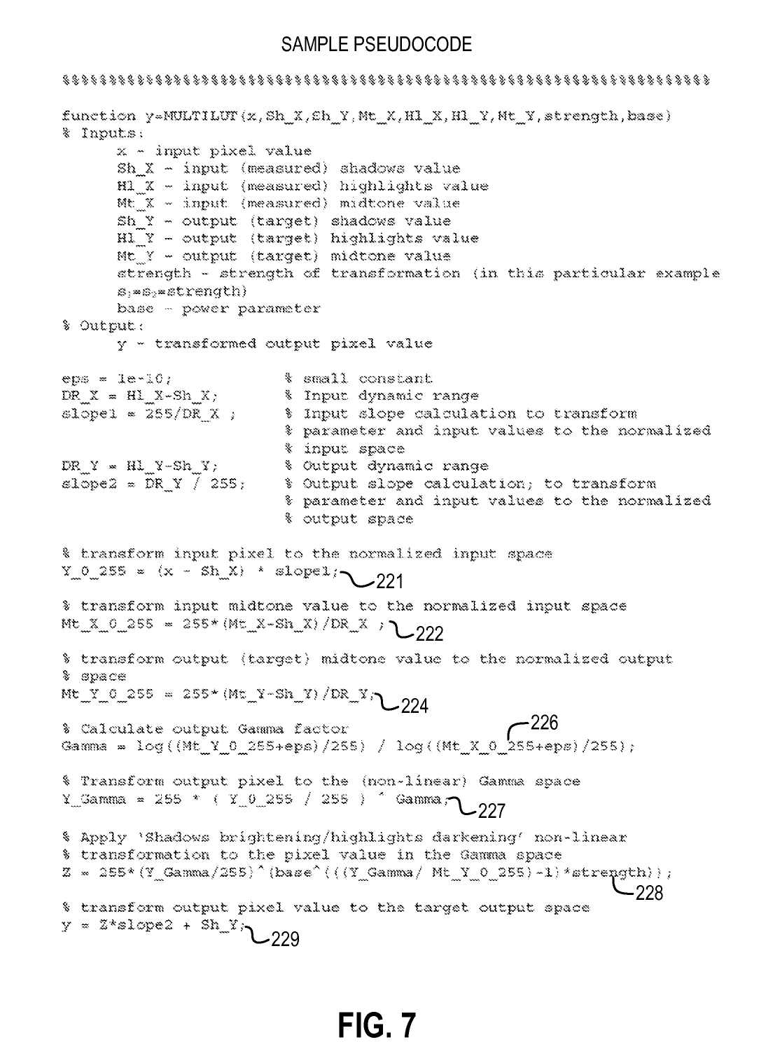

In step 162, a segment of the input image values 140 (which could be all such values or a subset of them), together with the measurements generated in step 161, preferably are normalized to a desired range. For example, the normalization range could be integers in the interval [0, 255] or real numbers in the interval [0, 1]. Line 221 (with respect to the input pixel values) 140 and line 222 (with respect to the relevant measurement) of the sample pseudocode shown in FIG. 7 illustrates one example of the former, although as indicated below, most of the individual operations performed in the example of FIG. 7 perform further scaling so as to use the range [0, 1].

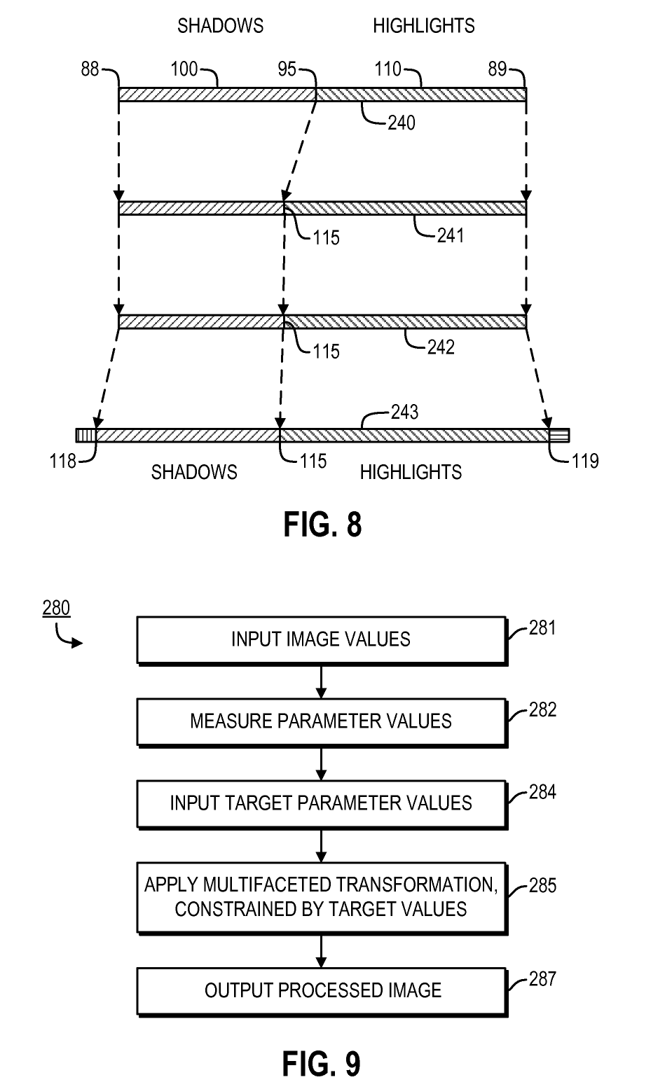

It is noted that in this example, the lower endpoint of the dynamic range Sh_X 88 and the upper endpoint of the dynamic range Hl_X 89 are defined as the endpoints of the normalized range, with just linear scaling between. The result is the normalized space 240, shown conceptually in FIG. 8.

At the same time, in step 152 the input target values 150 preferably also are normalized, more preferably, to the same range. Line 224 of the sample pseudocode shown in FIG. 7 illustrates such scaling, again with further scaling to the range [0, 1] occurring in certain subsequent individual operations.

Next, in steps 164-166 a sequence of additional individual image-value transform operations are performed on the input pixel values 140. Preferably, at least two such sequential operations are performed. As illustrated, the preferably normalized target values 150 constrain such operations in order to control the values of the image parameters across the image values that ultimately are output. A specific example is discussed with reference to FIG. 7.

In this example, step 164 is a gamma correction. Specifically, in step 226 a gamma is calculated, and in step 227 this gamma factor is applied to all of the normalized input pixel values 140. Referring to FIG. 8, it is noted that because of the manner in which the gamma factor is calculated in this example, the input mid-tone value Mt_X 95 (in normalized space) is shifted to the target output mid-tone value Mt_Y 115 (also in normalized space), as indicated by the change in the range of values 240 before gamma correction to the range of values 241 after gamma correction.

Step 165 is implemented in the present example as a combination shadow brightening and highlight darkening operation 228. Here, the operation has been structured so that when the normalized gamma-corrected input value (Y_Gamma) is equal to the normalized target output mid-tone value (Mt_Y_{—}0_{—}255), no modification occurs. For values above the normalized target output mid-tone value (Mt_Y_{—}0_{—}255), highlight darkening occurs, and for values below the normalized target output mid-tone value (Mt_Y_{—}0_{—}255), shadow brightening occurs, each with equal strength. In alternate embodiments, different strength values are specified for highlight darkening and shadow brightening. Thus, although the pixel values within each of the highlight range and the shadow range are modified, the target output mid-tone value Mt_Y 115 remains static in the normalized range, as shown by a comparison of range of values 241 prior to shadow brightening and highlight darkening operation 228 and range of values 242 after shadow brightening and highlight darkening operation 228.

In the present example, there are no additional pixel-value operations (i.e., no additional transform operations 166). In alternate embodiments, e.g., where different strength values are used for shadow brightening and highlight darkening, three or more separate sequential operations 164-166 may be performed.

Finally, in step 168 the image values are transformed from the normalized space to the desired output space. As shown in FIG. 7, this step preferably involves (in the present example) simply scaling to the target output dynamic range and adding in the target shadow value Sh_Y 118 (Sh_Y in line 229 of FIG. 7).

It should be noted that the sequence of pixel-value operations in the embodiment and the particular example given above (i.e., normalization, gamma correction, shadow brightening and highlight darkening and then transformation to output space) are just representative. In other embodiments and/or other examples within the above embodiment different sequences of transform operations may be performed within the overall transformation 45. One aspect of these embodiments, however, is that individual image-value operations are constrained by the target values in order to control the image parameters across the output image values.

In the particular example given above, the input dynamic range endpoints are made the endpoints of the normalized space, held there through the other pixel-value operations, and then scaled to the target values for the dynamic range endpoints in the final output-space transform operation. A similar approach can be used across a wide range of different embodiments.

The midpoint adjustment occurs in the particular example given above in the gamma correction step. As a result, the gamma factor is completely defined by the relationship between the input midpoint and the output midpoint. In systems where the user is to have control over the gamma factor, the shifting of the midpoint (or any other point between the endpoints, for that matter) can be performed in other pixel-value operation transform steps. Still further, the shifting can be divided between two or more different transform operations, all depending upon the effects to be achieved and where the user is to sacrifice some control over other transform operation parameters in order to be able to map the input measurements to the desired target values.

In the embodiment described above, it is generally contemplated that the mapping between the measured values and the target values will be exact. However, in alternate embodiments some amount of error is tolerated if necessary in order to allow the user to have greater control over other parameters of the overall image-processing transformation 45. Thus, even if the target values are not achieved exactly, they preferably are at least used to control the corresponding image parameters across the output image values.

Although the transformation 45 can be performed as a sequence of pixel-value operations on each individual image value, it generally will be preferable, particularly with respect to computational speed, to implement the entire transformation as a single formula or mapping. Combining the individual steps, for a generalization of the particular example given above, in which a shadows brightening strength parameter s₁ controls the extent to which the shadows will be brightened and a separate highlights darkening strength parameter s₂ controls the extent to which the highlights will be darkened, the output (that is, the transformed) value L(x) of each corresponding input pixel value x, is given by the following expression:

$$L ( x ) = \{ \begin{matrix}( Hl\_Y - Sh\_Y ) {( \frac{x - Sh\_X}{Hl\_X - Sh\_X} )}^{α {2}^{{s}_{1} β}} + Sh\_Y , Sh\_X \leq x \leq Mt\_X \\ ( Hl\_Y - Sh\_Y ) {( \frac{x - Sh\_X}{Hl\_X - Sh\_X} )}^{α {2}^{{s}_{2} β}} + Sh\_Y , Mt\_X < x \leq Hl\_X ,\end{matrix}$$

where

$$α = log [ \frac{( Mt\_Y - Sh\_Y ) ( Hl\_X - Sh\_X )}{( Mt\_X - Sh\_X ) ( Hl\_Y - Sh\_Y )} ] , \\ and$$

$$β = ( \frac{Hl\_Y - Sh\_Y}{Mt\_Y - Sh\_Y} ) {( \frac{x - Sh\_X}{Hl\_X - Sh\_X} )}^{α} - 1.$$

This transformation, in turn, can be applied either directly or through a lookup table.

Finally, it is noted that if the chosen mid-tone is the median, as in the example above, and the transforms are all monotonic and/or applied either exclusively above or exclusively below the mid-tone (i.e., with no crossover), then the target value for the output mid-tone also will be the median point of the output pixel values.

FIG. 9 illustrates a flow diagram for a process 280 for providing an image transformation according to a second representative embodiment of the present invention. More specifically, process 280 can be thought of as a generalization of process 135, described above. As with that process, the steps of process 280 preferably are performed in a fully automated manner so that the entire process 280 can be performed by executing computer-executable process steps from a computer-readable medium, or in any of the other ways described herein.

Initially, in step 281 image values are input for the input image 40.

Next, in step 282 values for specified parameters of the input image are measured. This step is similar to step 161, discussed above, and all the same considerations apply here.

In step 284, target parameter values are input. Once again, these values function as target values for one or more of these specified parameters. As above, this inputting step can include providing a user interface for an individual user 20 to provide such target parameter values.

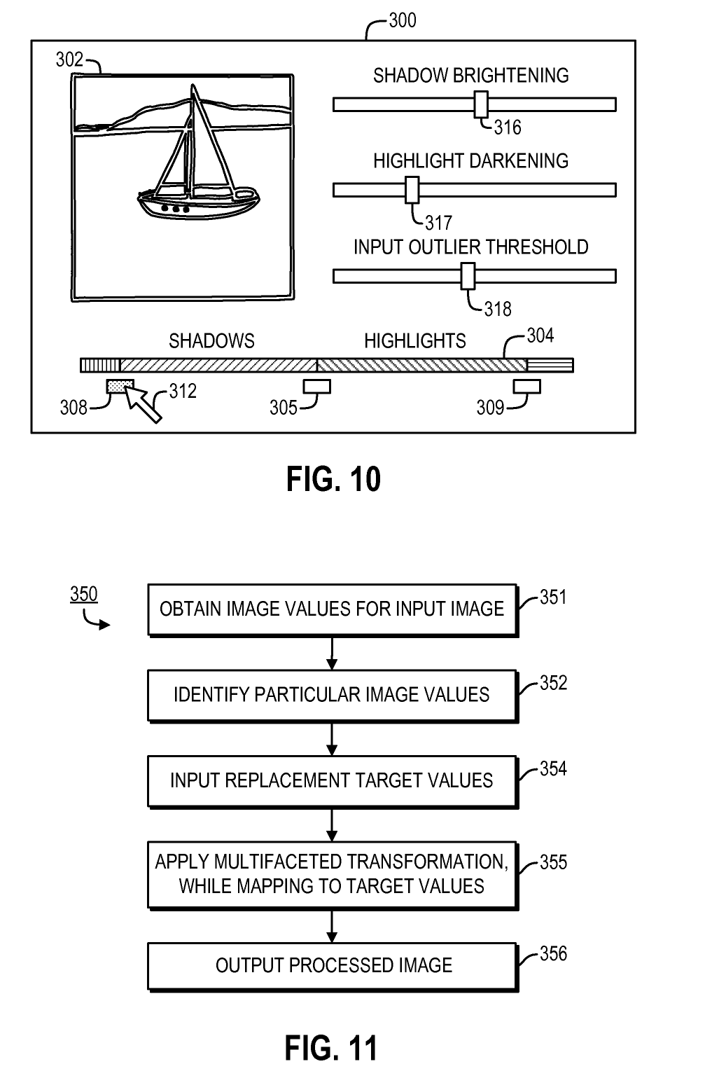

One example of such a user interface is shown in FIG. 10. Included within interface 300 is the subject image 302, which at different points in time may be the input image or some processed version of it. In addition, the interface 300 includes a graphical slider bar 304 by which the user 20 may designate, e.g., the target output mid-tone value Mt_Y 115 by using slider 305, the target value for the starting point of the shadows Sh_Y 118 using slider 308 or the target value for the ending point of the highlights Hl_Y 119 using slider 309. That is, in this embodiment the user 20 simply moves the cursor 312 to the desired slider (e.g., slider 308), left clicks her mouse and then drags the slider to the desired value. In this way, the user 20 can easily determine how much dynamic range is available in how much is allocated to each of shadows and highlights.

Similar sliders also are provided for adjusting other parameters of the transformation, such as a slider 316 for adjusting the strength of shadow brightening and a slider 317 for adjusting the strength of highlights darkening. In addition, a slider 318 may be provided for adjusting the locations of the input lower endpoint of the dynamic range Sh_X 88 and the upper endpoint of the dynamic range Hl_X 89, e.g., by adjusting the percentile with for each, with larger values (such as values close to one percentile point) potentially allowing greater expansion of the remaining dynamic range and with lower values (such as values close to zero) lessening the likelihood of unintentional clipping of significant information. Other graphic controls may be substituted for the sliders shown in FIG. 10.

In step 285, a multifaceted transformation is applied using the input target values for the parameters as constraints. As in the previous embodiment, this step contemplates the use of multiple image-value operations. In many cases, the transformation 45 is generated by sequential application of such image-value operations, as discussed above. However, in alternate embodiments a single multifaceted transformation is constructed in which the various aspects (e.g., gamma correction, shadow brightening and highlights darkening) are interdependent with each other.

Finally, in step 287 the processed image, as defined by the output image values, is output. This outputting step can include any or all of displaying the image on a monitor, printing it or providing it to another application for further processing.

FIG. 11 is a flow diagram illustrating a process 350 for providing an image transformation according to a third representative embodiment of the present invention. The steps of process 350 preferably are performed in a fully automated manner so that the entire process 350 can be performed by executing computer-executable process steps from a computer-readable medium, or in any of the other ways described herein.

Initially, in step 351 image values are obtained for an input image. Such image values can be simply retrieved from memory or another storage device, or can be received from an earlier image-processing stage.

In step 352, particular image values are identified. As in the preceding embodiments, such image values can be identified by performing calculations or measurements across the input image values, either with or without user input as to the calculation or measurement parameters (e.g., user definition of the criteria for cutting off outliers). Alternatively, some or all of image pixel values can be directly identified by the user (e.g., user 20).

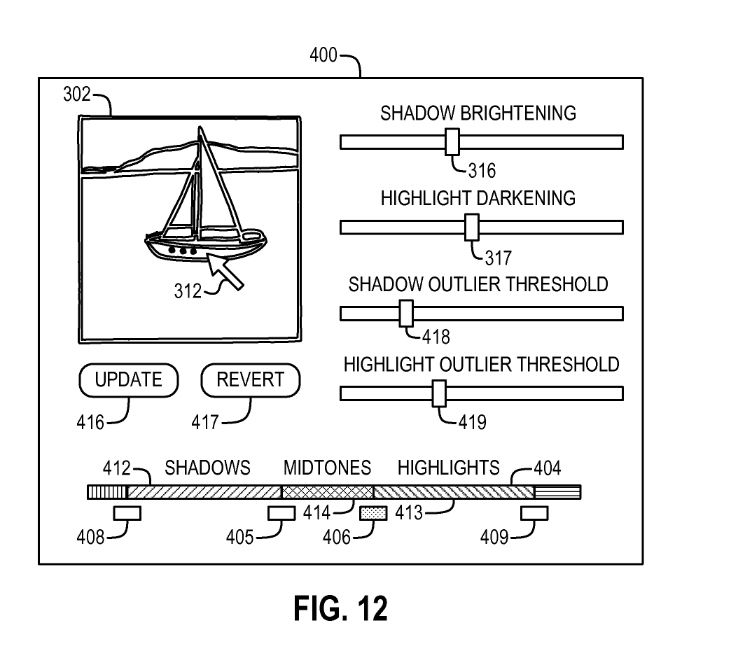

An example of such identification is shown in FIG. 12. Here, user interface 400 includes a display 302 of the input image, together with a slider bar 404 which is similar to slider bar 304, discussed above. However, in this interface 400 one or more of the segment endpoints are defined directly by the user 20. For example, the user 20 moves her cursor to a particular point in the displayed image 302, right clicks and then selects from: (1) start of shadows, (2) end of shadows, (3) start of highlights or (4) end of highlights. Upon doing so, the applicable position automatically is displayed on slider bar 404. In the specific example illustrated in FIG. 12, the user has selected “start of highlights” so that control 406 has been automatically inserted and/or moved to the appropriate position on slider bar 404. A similar procedure can be repeated for each of controls 408, 405 and 409. Alternatively, the user 20 might elect to simply accept the default (e.g., measured) values for the segment division points.

It is noted that in the present embodiment, it is possible to specify a mid-tone range rather than simply a mid-tone point. For example, in one embodiment brightening is to be performed in the shadow region 412, darkening is to be performed in the highlights region 413, and neither brightening nor darkening is to be performed in the mid-tone region 414. More generally, any number or kinds of segments preferably may be defined by the user 20 in this embodiment of the invention, e.g., depending upon the particular types of processing that are desired and supported.

Returning to FIG. 11, in step 354 replacement pixel values are input for some or all of the pixel values identified in step 352. In the case of the user interface 400, the user 20 preferably specifies such replacement values merely by dragging the appropriate sliders 405, 406, 408 and 409 (or manipulating any other graphical controls that are provided), as desired.

In step 355, a multifaceted transformation 45 (e.g., having different kinds of image-values operations) is applied to the input image values, constrained by the condition that the image values identified in step 352 are mapped (either exactly or, in certain embodiments, within certain tolerances) to the corresponding replacement values input in step 354. Considerations pertaining to such a multifaceted transformation 45 have been discussed above. Performance of this step 355 may be triggered by any changes input in step 354; alternatively, referring to FIG. 12, the transformation may be applied only when the user 20 selects the update button 416. In this example, the user 20 preferably has the ability to modify the replacement target values in different ways and view the results for each, until she is satisfied with the end result, clicking the “revert” button 417 to return to the original input image (which preferably is saved), whenever desired.

Finally, in step 356 the processed image is output. For example, as noted above, the image may simply be displayed on user interface 400 or may be printed or output to another application for additional processing.

### System Environment.

Generally speaking, except where clearly indicated otherwise, all of the systems, methods and techniques described herein can be practiced with the use of one or more programmable general-purpose computing devices. Such devices typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a firewire connection, or using a wireless protocol, such as Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system), which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and a printer); one or more input devices (such as a mouse, touchpad, tablet, touch-sensitive display or other pointing device, a keyboard, a keypad, a microphone and a scanner); a mass storage unit (such as a hard disk drive); a real-time clock; a removable storage read/write device (such as for reading from and writing to RAM, a magnetic disk, a magnetic tape, an opto-magnetic disk, an optical disk, or the like); and a modem (e.g., for sending faxes or for connecting to the Internet or to any other computer network via a dial-up connection). In operation, the process steps to implement the above methods and functionality, to the extent performed by such a general-purpose computer, typically initially are stored in mass storage (e.g., the hard disk), are downloaded into RAM and then are executed by the CPU out of RAM. However, in some cases the process steps initially are stored in RAM or ROM.

Suitable devices for use in implementing the present invention may be obtained from various vendors. In the various embodiments, different types of devices are used depending upon the size and complexity of the tasks. Suitable devices include mainframe computers, multiprocessor computers, workstations, personal computers, and even smaller computers such as PDAs, wireless telephones or any other appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented in software, hardware, firmware or any combination of these, with the particular implementation being selected based on known engineering tradeoffs. More specifically, where the functionality described above is implemented in a fixed, predetermined or logical manner, it can be accomplished through programming (e.g., software or firmware), an appropriate arrangement of logic components (hardware) or any combination of the two, as will be readily appreciated by those skilled in the art.

It should be understood that the present invention also relates to machine-readable media on which are stored program instructions for performing the methods and functionality of this invention. Such media include, by way of example, magnetic disks, magnetic tape, optically readable media such as CD ROMs and DVD ROMs, or semiconductor memory such as PCMCIA cards, various types of memory cards, USB memory devices, etc. In each case, the medium may take the form of a portable item such as a miniature disk drive or a small disk, diskette, cassette, cartridge, card, stick etc., or it may take the form of a relatively larger or immobile item such as a hard disk drive, ROM or RAM provided in a computer or other device.

The foregoing description primarily emphasizes electronic computers and devices. However, it should be understood that any other computing or other type of device instead may be used, such as a device utilizing any combination of electronic, optical, biological and chemical processing.

### Additional Considerations.

In certain instances, the foregoing description refers to clicking or double-clicking on user-interface buttons, dragging user-interface items, or otherwise entering commands or information via a particular user-interface mechanism and/or in a particular manner. All of such references are intended to be exemplary only, it being understood that the present invention encompasses entry of the corresponding commands or information by a user in any other manner using the same or any other user-interface mechanism. In addition, or instead, such commands or information may be input by an automated (e.g., computer-executed) process.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of processing an image, comprising:
obtaining input image values for an input image;
measuring values for image parameters across the input image values;
inputting target values for the image parameters;
applying a transformation to the input image values to produce corresponding output image values, the transformation having been generated as a result of a plurality of individual image-value operations that have been constrained by the target values in order to control the image parameters across the output image values; and
outputting a processed output image based on the output image values.

2. A method according to claim 1, wherein the transformation has been generated by applying the individual image-value operations in a sequential manner.

3. A method according to claim 1, wherein the transformation is applied as a single function.

4. A method according to claim 3, wherein the single function is implemented through a lookup table.

5. A method according to claim 1, wherein the image parameters comprise endpoints of a dynamic range for the input image values.

6. A method according to claim 1, wherein the image parameters further comprise a midpoint of a specified range of the input image values.

7. A method according to claim 1, wherein the individual image-value operations comprise at least two of: dynamic range modification, gamma correction, highlight darkening and shadow brightening.

8. A method according to claim 1, wherein the individual image-value operations have been constrained by the target values in order to ensure that the image parameters have the target values across the output image values.

9. A method according to claim 1, wherein the individual image-value operations include a gamma correction, the image parameters comprise a midpoint of a specified range, and the measured value of the specified range midpoint is adjusted to the target value for the specified range midpoint during the gamma correction.

10. A method according to claim 1, wherein the individual image-value operations comprise normalizing a segment of the image values to a pre-specified range.

11. A method according to claim 10, wherein the segment comprises a dynamic range of the image values, and wherein the individual image-value operations further comprise scaling the image values in the pre-specified range to an output dynamic range defined by the target values.

12. A method according to claim 1, wherein the processed output image is displayed in the outputting step.

13. A method according to claim 1, wherein said inputting step comprises displaying a user interface that allows a user to graphically select at least one of the target values.

14. A method of processing an image, comprising:
obtaining input values for pixels in an input image;
inputting target values to replace identified ones of the input values;
applying a transformation to the input values for the pixels in order to produce corresponding output image values, wherein the transformation includes plural individual image-value operations and maps the identified ones of the input values to the target values; and
outputting a processed output image based on the output image values.

15. A method according to claim 14, wherein the transformation has been generated by applying the individual image-value operations in a sequential manner.

16. A method according to claim 14, further comprising a step of inputting a transformation parameter that controls a degree of modification effected by at least one of the individual image-value operations.

17. A method according to claim 16, wherein the transformation parameter comprises at least one of a strength of shadow brightening or a strength of highlight darkening.

18. A method according to claim 14, wherein the individual image-value operations comprise normalizing a segment of the image values to a pre-specified range.

19. A method according to claim 14, wherein said inputting step comprises displaying a user interface that allows a user to graphically select at least one of the target values.

20. A computer-readable medium storing computer-executable process steps for processing an image, said process steps comprising:
obtaining input image values for an input image;
measuring values for image parameters across the input image values;
inputting target values for the image parameters;
applying a transformation to the input image values to produce corresponding output image values, the transformation having been generated as a result of a plurality of individual image-value operations that have been constrained by the target values in order to control the image parameters across the output image values; and
outputting a processed output image based on the output image values.
